(19) United States
(12) Patent Application Publication
(10) Pub. No.: US 2026/0352107 A1
(43) Pub. Date: Nov. 5, 2026

(54) Power Supply Device and Temperature Regulation Method

(71) Applicant: PowerX Semiconductor Corporation, Hsinchu County (TW)

(72) Inventors: Ding-Yu Wei, Hsinchu County (TW); Tsung-Wei Huang, Hsinchu County (TW)

(73) Assignee: PowerX Semiconductor Corporation, Hsinchu County (TW)

(21) Appl. No.: 19/262,140

(22) Filed: Jul. 8, 2025

(30) Foreign Application Priority Data
Apr. 30, 2025 (TW) 114116289

(51) Int. Cl. H02M 3/158; H02M 1/00

(52) U.S. Cl. CPC H02M 3/158; H02M 1/0003

(57) ABSTRACT

A power supply device includes a power switch, a control circuit, and a temperature sensing circuit. The power switch converts input voltage signal into output voltage signal based on a control signal. The control circuit generates and adjusts the control signal based on a first over-temperature protection signal to regulate operating temperature. The temperature sensing circuit includes a reference voltage generating circuit, a first MOSFET, and a first comparison circuit. The reference voltage generating circuit generates a reference voltage signal based on a first reference voltage and the input voltage signal. The first MOSFET, disposed on the power switch, has a drain electrically connected to the input voltage signal, a gate electrically connected to a second reference voltage, and a source generating a first sensing voltage signal. The first comparison circuit compares the first sensing voltage signal with the reference voltage signal to generate the first over-temperature protection signal.

### BACKGROUND of the INVENTION

### 1. Field Of The Invention

The present invention relates to a power supply device and a temperature regulation method, and more particularly, to a power supply device and a temperature regulation method capable of precisely monitoring and real-time regulating a temperature of a power switch.

### 2. Description of the Prior Art

In modern electronic systems, power management technology plays a critical role, and power switches are widely utilized in power supply devices to achieve voltage or current conversion and regulation. In high-power applications, such as amplifiers, switching regulators, linear regulators, LED drivers, and battery management integrated circuits, power metal-oxide-semiconductor field-effect transistors (Power MOSFETs, hereinafter referred to as Power MOS) are commonly used as power switch components due to their high efficiency and fast response characteristics. To enhance the power handling capability and reliability of systems, conventional technologies often employ a multi-chip module (MCM) packaging architecture, which integrates the Power MOS and the control circuit into a single package. However, this configuration faces several technical challenges in practical applications, particularly those related to temperature sensing and thermal management.

In the prior art, temperature monitoring of power switches typically relies on conventional bipolar junction transistor (BJT) temperature sensing elements. However, when the power switch is implemented by a Power MOS and integrated into an MCM architecture, the BJT temperature sensing element cannot be directly disposed on the Power MOS platform due to differences in manufacturing processes prevent. Consequently, the control circuit can only indirectly sense the temperature surrounding the Power MOS rather than the actual temperature of the Power MOS itself. Generally, current flowing through the Power MOS generates significant heat, which directly affects its operating temperature. However, indirect sensing results in inaccurate temperature data, which fails to effectively reflect the thermal state of the Power MOS. Furthermore, when the Power MOS overheats, heat must be transferred to the temperature sensing element at the control circuit end to trigger a protection mechanism. This delay may cause a slow response, which may lead to the burnout of the Power MOS before the protection mechanism is activated, thereby affecting the reliability and stability of the system.

Therefore, there is an urgent need in the industry for a technical solution capable of accurately sensing the temperature of a power switch to enhance the performance and reliability of power supply devices.

### SUMMARY OF THE INVENTION

Therefore, the present invention is to provide a power supply device and a temperature regulation method capable of accurately sensing the temperature of a power switch.

An embodiment of the present invention discloses a power supply device, configured to receive an input voltage signal and generate an output voltage signal, which comprises a power switch, configured to convert the input voltage signal into the output voltage signal based on a control signal; a control circuit, configured to generate the control signal to drive the power switch, and configured to adjust the control signal based on a first over-temperature protection signal to regulate an operating temperature of the power switch; and a temperature sensing circuit, comprising a reference voltage generating circuit, configured to generate a reference voltage signal based on a first reference voltage and the input voltage signal; a first metal-oxide-semiconductor field-effect transistor (MOSFET), disposed on the power switch, wherein the first MOSFET comprises a drain electrically connected to the input voltage signal, a gate electrically connected to a second reference voltage, and a source generating a first sensing voltage signal; and a first comparison circuit, electrically connected to the source of the first MOSFET to receive the first sensing voltage signal and further electrically connected to the reference voltage generating circuit and the control circuit, configured to compare the first sensing voltage signal with the reference voltage signal to generate the first over-temperature protection signal, and configured to output the first over-temperature protection signal to the control circuit.

Another embodiment of the present invention discloses a temperature regulation method for a power supply device, wherein a power switch of the power supply device is configured to convert an input voltage signal into an output voltage signal based on a control signal. The temperature regulation method comprises generating a reference voltage signal based on a first reference voltage and the input voltage signal; disposing a first metal-oxide-semiconductor field-effect transistor (MOSFET) on the power switch, wherein the first MOSFET comprises a drain electrically connected to the input voltage signal, a gate electrically connected to a second reference voltage, and a source generating a first sensing voltage signal; and comparing the first sensing voltage signal with the reference voltage signal to generate a first over-temperature protection signal, wherein the first over-temperature protection signal is used to adjust the control signal to regulate an operating temperature of the power switch.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power supply device according to an embodiment of the present invention.

FIG. 2 is a schematic diagram illustrating a relationship between a threshold voltage and temperature of a metal-oxide-semiconductor field-effect transistor.

FIG. 3 is a schematic diagram illustrating a relationship between a first sensing voltage signal and a drain-source voltage in FIG. 1.

FIG. 4 is a schematic diagram of a reference voltage generating circuit according to an embodiment of the present invention.

FIG. 5A, FIG. 5B, and FIG. 5C are schematic diagrams illustrating variations of related signals in FIG. 1 at different temperatures.

FIG. 6A and FIG. 6B are schematic diagrams illustrating variations of related signals without and with a compensation mechanism, respectively.

FIG. 7A and FIG. 7B are schematic diagrams illustrating the timing of level changes of an over-temperature protection signal without and with a compensation mechanism, respectively.

FIG. 8 is a schematic diagram of a power supply device according to another embodiment of the present invention.

FIG. 9 is a schematic diagram of a temperature regulation process according to an embodiment of the present invention.

### DETAILED DESCRIPTION

When a power switch is implemented by a Power MOS and integrated into an MCM architecture, one feasible technique for sensing the temperature of the Power MOS is to place a small metal-oxide-semiconductor field-effect transistor (MOSFET) around the Power MOS as a temperature sensing element, and utilize the negative temperature coefficient characteristic of its threshold voltage (Vth) for temperature sensing. However, this method is limited by variations in the input voltage in practical applications. Specifically, changes in the drain-source voltage of the MOSFET cause a channel length modulation effect, which leads to unintended variations in the sensing voltage due to the input voltage, thereby reducing the accuracy of temperature sensing.

To address the above issue, the present invention provides a power supply device and a temperature regulation method, which achieve precise sensing and real-time regulation of the temperature of the power switch by disposing a temperature sensing element on the power switch and incorporating an input voltage slope compensation technique, thereby enhancing the performance and reliability of the system.

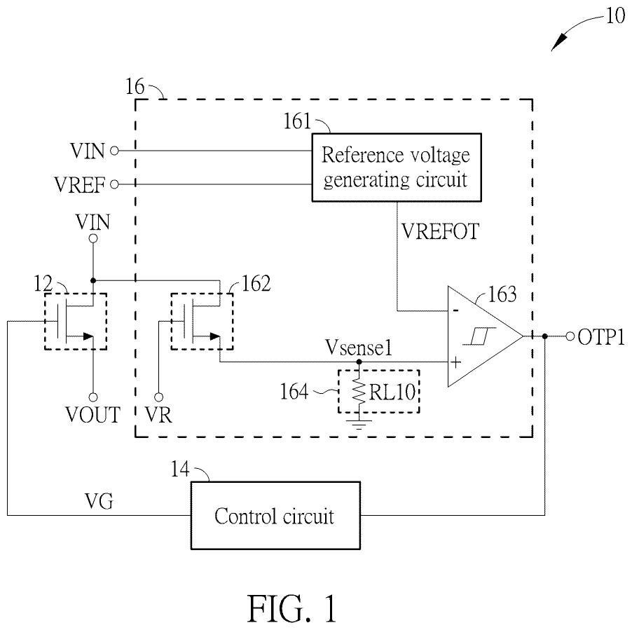

Please refer to FIG. 1, which is a schematic diagram of a power supply device 10 according to an embodiment of the present invention. The power supply device 10 includes a power switch 12, a control circuit 14, and a temperature sensing circuit 16. The power supply device 10 is configured to receive an input voltage signal VIN and generate an output voltage signal VOUT, and is capable of sensing a temperature on the power switch 12 and controlling the power switch 12 based on the sensed temperature to achieve temperature regulation of the power switch 12. Specifically, the power switch 12 converts the input voltage signal VIN into the output voltage signal VOUT based on a control signal VG generated by the control circuit 14. The control circuit 14 is configured to generate the control signal VG to drive the power switch 12 and further configured to adjust the control signal VG based on a first over-temperature protection signal OTP1 provided by the temperature sensing circuit 16, thereby regulating an operating temperature of the power switch 12. The temperature sensing circuit 16 includes a reference voltage generating circuit 161, a first MOSFET 162, and a first comparison circuit 163. The reference voltage generating circuit 161 generates a reference voltage signal VREFOT (also referred to as a slope-compensated reference voltage signal VREFOT) based on a first reference voltage VREF and the input voltage signal VIN. In one embodiment, the first reference voltage VREF is preferably a constant value which is determined based on a temperature threshold for over-temperature protection. The first MOSFET 162, which serves as a temperature sensing element, is disposed on the power switch 12, and has a drain electrically connected to the input voltage signal VIN, a gate electrically connected to a second reference voltage VR, and a source generating a first sensing voltage signal Vsense1. The second reference voltage VR is preferably a constant value, which enables the first MOSFET 162 to operate at a fixed gate voltage, thereby more accurately reflecting the impact of temperature variations on the first sensing voltage signal Vsense1 to enhance the stability and accuracy of temperature sensing. Additionally, one end of a load 164 is electrically connected between the source of the first MOSFET 162 and a positive terminal (+) of the first comparison circuit 163, while the other end of the load 164 is electrically connected to a ground terminal. Referring to FIG. 1, in this embodiment, the load 164 is implemented as a resistor RL10. The positive terminal (+) of the first comparison circuit 163 receives the first sensing voltage signal Vsense1, and the negative terminal (−) thereof is electrically connected to the reference voltage generating circuit 161 to receive the reference voltage signal VREFOT. The first comparison circuit 163 compares the first sensing voltage signal Vsense1 with the reference voltage signal VREFOT to generate the first over-temperature protection signal OTP1 and outputs it to the control circuit 14, to enable the control circuit 14 to adjust the control signal VG accordingly.

In this embodiment, the power switch 12 is a power MOSFET, the operating principle of which is well-known to those skilled in the art. The first MOSFET 162 and the power MOSFET implementing the power switch 12 are manufactured using the same process. In one embodiment, the power switch 12, the control circuit 14, and the temperature sensing circuit 16 are integrated into a multi-chip module (MCM) packaging architecture. Specifically, the power switch 12 and the first MOSFET 162 of the temperature sensing circuit 16 are disposed on one chip, while the control circuit 14, the reference voltage generating circuit 161, the first comparison circuit 163, and the load 164 of the temperature sensing circuit 16 are disposed on another chip. These two chips are integrated into a single package, and connected with each other through wire bonding. This configuration enables the temperature sensing circuit 16 to directly sense the temperature on the power switch 12 via the first MOSFET 162, which significantly improves the accuracy and immediacy of temperature sensing compared to conventional indirect sensing methods.

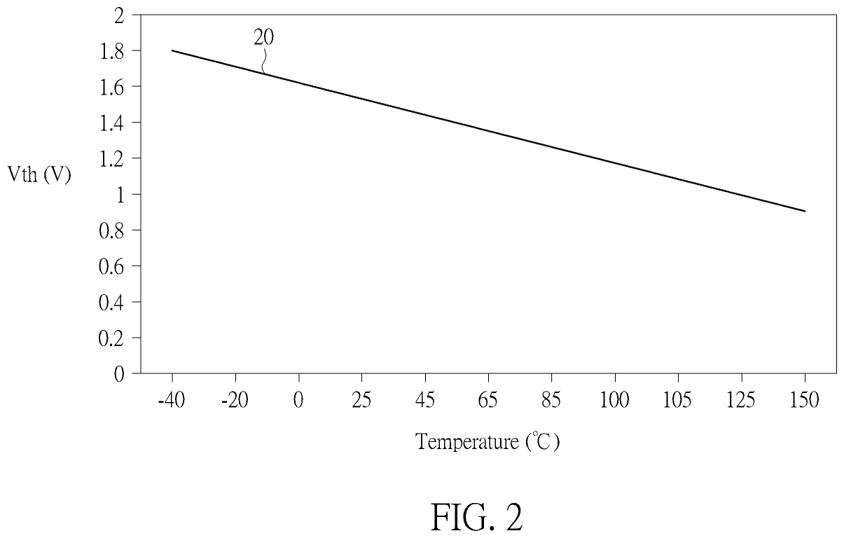

In detail, please refer to FIG. 2, which is a schematic diagram of a curve 20. The curve 20 illustrates a relationship between a threshold voltage Vth of the first MOSFET 162 and temperature. As shown by the curve 20, the threshold voltage Vth decreases as the temperature rises, which exhibits a negative temperature coefficient characteristic. This characteristic enables the first MOSFET 162 to convert temperature variations into changes in the first sensing voltage signal Vsense1. Specifically, as the temperature increases, the threshold voltage Vth decreases, which causes the first sensing voltage signal Vsense1 to increase; conversely, as the temperature decreases, the threshold voltage Vth increases, which causes the first sensing voltage signal Vsense1 to decrease. Thus, the first sensing voltage signal Vsense1 exhibits a positive temperature coefficient characteristic, and serves as an indicator for temperature sensing.

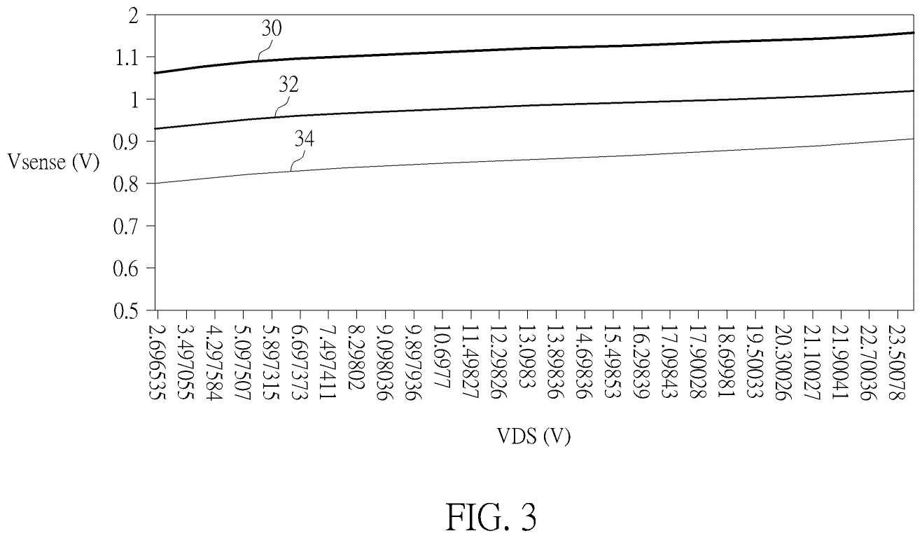

However, variations in the input voltage signal VIN affect the accuracy of the first sensing voltage signal Vsense1 due to the channel length modulation effect. For example, please refer to FIG. 3, which is a schematic diagram of curves 30, 32, and 34. The curves 30, 32, and 34 represent the relationships between the first sensing voltage signal Vsense1 and a drain-source voltage VDS of the first MOSFET 162 when the resistance of the resistor RL10 is 100 ohms, 1K ohms, and 10K ohms, respectively. As shown in FIG. 3, at the same drain-source voltage VDS, the higher the resistance of the resistor RL10, the lower the first sensing voltage signal Vsense1. Additionally, at the same resistance of the resistor RL10 and the same temperature, the first sensing voltage signal Vsense1 varies with changes in the drain-source voltage VDS due to the channel length modulation effect.

The channel length modulation effect refers to a slight reduction in the effective channel length of the first MOSFET 162 as the drain-source voltage VDS increases, which leads to an increase in output current and causes an additional offset in the first sensing voltage signal Vsense1. In other words, even if the temperature remains constant, the first sensing voltage signal Vsense1 varies with changes in the drain-source voltage VDS, and the drain-source voltage VDS is related to the input voltage signal VIN, which results in unintended variations in the first sensing voltage signal Vsense1 due to the input voltage signal VIN, thereby reducing the accuracy of temperature sensing. To address this issue, the present invention associates the reference voltage signal VREFOT with the input voltage signal VIN, such that the reference voltage signal VREFOT increases as the input voltage signal VIN increases or the reference voltage signal VREFOT decreases as the input voltage signal VIN decreases (i.e., input voltage slope compensation technique). This dynamic adjustment mechanism of the reference voltage signal VREFOT compensates for or offsets non-temperature-related variations in the first sensing voltage signal Vsense1 caused by the channel length modulation effect, to ensure that the comparison result between the first sensing voltage signal Vsense1 and the reference voltage signal VREFOT reflects actual temperature variations.

Further, the first comparison circuit 163 compares the first sensing voltage signal Vsense1 with the compensated reference voltage signal VREFOT. When the first sensing voltage signal Vsense1 exceeds the compensated reference voltage signal VREFOT, indicating that the temperature of the power switch 12 is too high, the first comparison circuit 163 generates the first over-temperature protection signal OTP1 or adjusts a level of the first over-temperature protection signal OTP1, to notify the control circuit 14 to adjust the control signal VG, for example, by pulling the control signal VG low to reduce a conduction degree of the power switch 12 or to turn off the power switch 12, thereby preventing damage due to overheating.

In short, in the power supply device 10, the reference voltage signal VREFOT generated by the reference voltage generating circuit 161 is not only related to the fixed first reference voltage VREF but also related to the input voltage signal VIN, such that the reference voltage signal VREFOT can dynamically track changes in the input voltage signal VIN, thereby effectively compensating for the impact of the channel length modulation effect on temperature sensing. In other words, the operation of the reference voltage generating circuit 161 can be regarded as synthesizing the first reference voltage VREF and a portion of the input voltage signal VIN to form the reference voltage signal VREFOT. Thus, the reference voltage signal VREFOT dynamically tracks changes in the input voltage signal VIN, to offset or compensate for the impact of the channel length modulation effect on temperature sensing. Therefore, the present invention significantly enhances the accuracy of temperature sensing and improves the reliability and stability of the system.

To enable the reference voltage signal VREFOT to dynamically track changes in the input voltage signal VIN, in one embodiment, the reference voltage generating circuit 161 generates the reference voltage signal VREFOT based on the input voltage signal VIN and the first reference voltage VREF, to satisfy the following relationship:

VREFOT=VREF+VIN×Gain; (Eq. 1)

where Gain is a gain coefficient. Therefore, by adjusting the gain coefficient Gain, the reference voltage signal VREFOT varies with changes in the input voltage signal VIN, so as to achieve dynamical compensation, thereby offsetting or compensating for errors introduced in the first sensing voltage signal Vsense1 due to variations in the input voltage signal VIN.

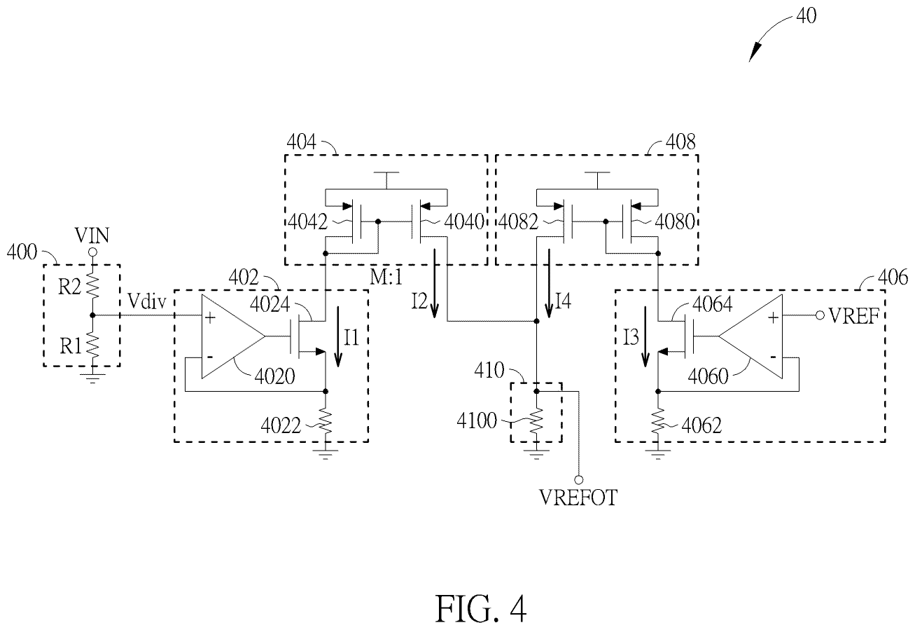

It should be noted that the implementation of the reference voltage generating circuit 161 is not limited to a specific architecture, as long as the reference voltage signal VREFOT can vary with changes in the input voltage signal VIN, for example, to satisfy the relationship in Eq. 1. For instance, please refer to FIG. 4, which is a schematic diagram of a reference voltage generating circuit 40 according to an embodiment of the present invention. The reference voltage generating circuit 40 is used to implement the reference voltage generating circuit 161 and includes a voltage divider circuit 400, a first voltage-to-current conversion circuit 402, a first current mirror 404, a second voltage-to-current conversion circuit 406, a second current mirror 408, and a current-to-voltage conversion circuit 410. The voltage divider circuit 400, which is composed of resistors R1 and R2 connected in series, is electrically connected to the input voltage signal VIN to divide the input voltage signal VIN and generate a divided voltage signal Vdiv, i.e., Vdiv=VIN×(R1/(R1+R2)). The first voltage-to-current conversion circuit 402, which is composed of an operational amplifier 4020, a resistor 4022, and a MOSFET 4024, operates in a manner well-known to those skilled in the art. In brief, the first voltage-to-current conversion circuit 402 converts the divided voltage signal Vdiv into a first current I1. The first current mirror 404, which is composed of transistors 4040 and 4042, converts the first current I1 into a second current I2, where I2=I1×M, and M is a current mirror ratio of the first current mirror 404 and typically determined by a size ratio of the transistors 4040 and 4042 in the first current mirror 404, to provide amplification, reduction, or mirroring of the current. The operation of the first current mirror 404 is well-known to those skilled in the art. The second voltage-to-current conversion circuit 406 has the same circuit structure as the first voltage-to-current conversion circuit 402, is composed of an operational amplifier 4060, a resistor 4062, and a MOSFET 4064, and is configured to convert the first reference voltage VREF into a third current I3. The second current mirror 408, which is composed of transistors 4080 and 4082, mirrors the current to convert the third current I3 output by the second voltage-to-current conversion circuit 406 into a fourth current I4. The current-to-voltage conversion circuit 410, which is implemented by a resistor 4100, sums the second current I2 and the fourth current I4 and converts the summed current into a voltage signal to generate the reference voltage signal VREFOT.

In the reference voltage generating circuit 40, a component of the input voltage signal VIN is adjusted through the voltage divider circuit 400 and the current mirror ratio M of the first current mirror 404 and then summed with a component of the first reference voltage VREF to form the compensated reference voltage signal VREFOT. In such a situation, the gain coefficient Gain can be expressed as:

Gain=(R1/(R1+R2))/M; (Eq. 2)

where (R1/(R1+R2)) is a ratio of the divided voltage signal Vdiv to the input voltage signal VIN. In other words, the component of the input voltage signal VIN in the reference voltage signal VREFOT is related to the ratio of the divided voltage signal Vdiv to the input voltage signal VIN and the current mirror ratio M. Therefore, by adjusting the resistors R1, R2, and the current mirror ratio M, the component of the input voltage signal VIN in the reference voltage signal VREFOT can be precisely controlled, thereby modulating the gain coefficient Gain to match characteristics of the first MOSFET 162, so as to ensure that the compensated reference voltage signal VREFOT accurately compensates for variations in the first sensing voltage signal Vsense1 caused by the input voltage signal VIN.

It should be noted that the adjustment of the gain coefficient Gain can be performed during the production or manufacturing stage of the power supply device 10 to ensure that the reference voltage signal VREFOT precisely matches the characteristics of the first MOSFET 162. Specifically, manufacturers can detect the first sensing voltage signal Vsense1 under different input voltage signals VIN and dynamically adjust the resistors R1, R2, and the current mirror ratio M to optimize the gain coefficient Gain. This adjustment can be achieved through laser trimming or a programmable resistor network, to ensure that each power supply device achieves optimal temperature compensation before leaving the factory. Additionally, during system operation, if environmental conditions or component aging cause characteristic drift, the gain coefficient Gain can be fine-tuned through software or hardware feedback mechanisms to maintain the accuracy of temperature sensing.

Furthermore, the reference voltage generating circuit 40 is one embodiment of the reference voltage generating circuit 161. Those skilled in the art may employ various electronic components or modules to achieve the same function or make different modifications, without being limited thereto. For example, the voltage divider circuit 400 can be implemented not only by series-connected resistors, but also by a digitally controlled adjustable voltage divider. In an embodiment, the first voltage-to-current conversion circuit 402 and the second voltage-to-current conversion circuit 406 can be implemented by a combination of an operational amplifier, a resistor, and a MOSFET; in another embodiment, the first voltage-to-current conversion circuit 402 and the second voltage-to-current conversion circuit 406 can be implemented by a voltage-controlled current source (VCCS) module or any circuit capable of converting voltage to current. The first current mirror 404 and the second current mirror 408, which is used to amplify, reduce, or mirror current, can be implemented by any circuit or module with the same function. The current-to-voltage conversion circuit 410, which is used to convert current to voltage, is not limited to a resistor but can be implemented by any circuit or module with the same function. Additionally, it is worth noting that the resistors used in the first voltage-to-current conversion circuit 402, the second voltage-to-current conversion circuit 406, and the current-to-voltage conversion circuit 410 are preferably of the same resistance value to ensure consistent temperature coefficients in the circuit, reduce errors caused by temperature variations and enhance system stability. However, depending on design requirements, resistors with different resistance values or adjustable resistors can be used to achieve more flexible adjustment functions.

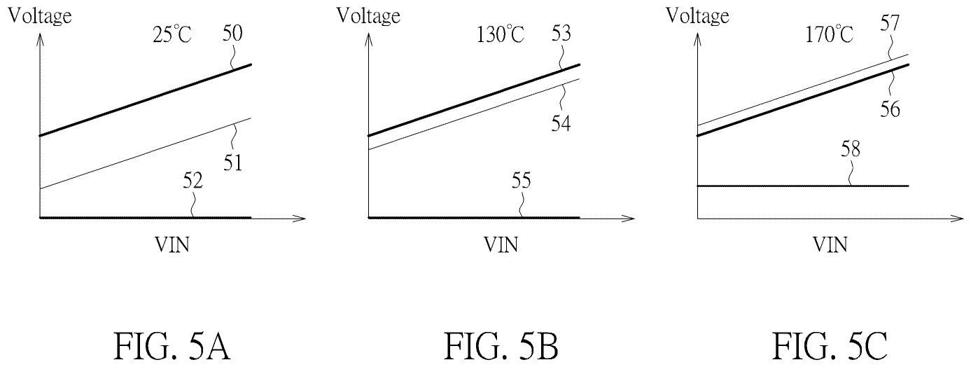

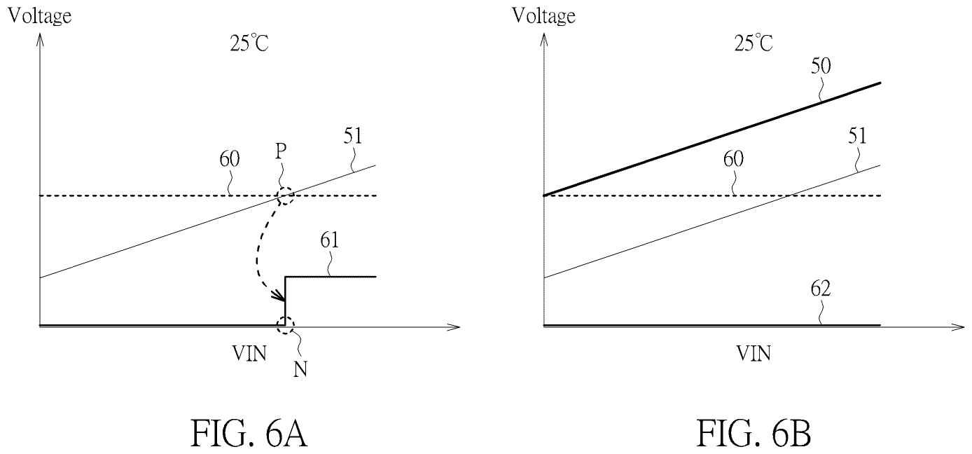

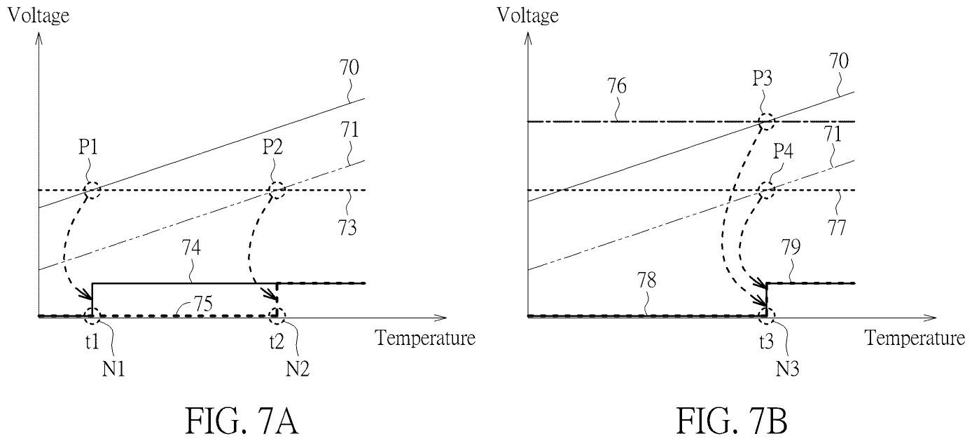

To illustrate the effect of the compensation mechanism of the present invention more clearly, please refer to FIG. 5A to FIG. 5C, FIG. 6A, FIG. 6B, FIG. 7A, and FIG. 7B. First, assume that the system requires temperature protection for the power switch 12 when its temperature exceeds 150° C. (i.e., the temperature threshold for over-temperature protection). FIG. 5A, FIG. 5B, and FIG. 5C are schematic diagrams illustrating variations of the first sensing voltage signal Vsense1, the compensated reference voltage signal VREFOT, and the first over-temperature protection signal OTP1 for different input voltage signals VIN when the power switch 12 operates at 25° C., 130° C., and 170° C., respectively. In FIG. 5A, FIG. 5B, and FIG. 5C, the horizontal axis represents the input voltage signal VIN, the vertical axis represents voltage, curves 50, 53, and 56 represent the compensated reference voltage signal VREFOT, and curves 51, 54, and 57 represent the first sensing voltage signal Vsense1, and curves 52, 55, and 58 represent the first over-temperature protection signal OTP1. As shown in FIG. 5A, FIG. 5B, and FIG. 5C, both the first sensing voltage signal Vsense1 and the compensated reference voltage signal VREFOT vary in the same direction as the input voltage signal VIN, i.e., as the input voltage signal VIN increases, both the first sensing voltage signal Vsense1 and the compensated reference voltage signal VREFOT also increase. As can be known by comparing FIG. 5A, FIG. 5B, and FIG. 5C, when the temperature of the power switch 12 is below 150° C. (i.e., FIG. 5A and FIG. 5B), the first over-temperature protection signal OTP1 remains at a low level, which allows the power switch 12 to continue operating. When the temperature of the power switch 12 reaches 150° C. (i.e., FIG. 5C), the first over-temperature protection signal OTP1 switches to a high level, to notify the control circuit 14 to adjust the control signal VG, for example, by pulling the control signal VG low to reduce the conduction degree of the power switch 12 or to turn off the power switch 12, thereby preventing damage due to overheating.

Next, please refer to FIG. 6A and FIG. 6B. FIG. 6A and FIG. 6B are schematic diagrams illustrating variations of the first sensing voltage signal Vsense1 and the first over-temperature protection signal OTP1 without and with the compensation mechanism of the present invention, respectively. FIG. 6A and FIG. 6B continue the example of FIG. 5A, i.e., the power switch 12 operates at 25° C., the horizontal axis represents the input voltage signal VIN, and the vertical axis represents voltage. The curve 50 represents the compensated reference voltage signal VREFOT, and the curve 51 represents the first sensing voltage signal Vsense1. Additionally, in FIG. 6A and FIG. 6B, a curve 60 represents a level of the first reference voltage VREF, a curve 61 represents the first over-temperature protection signal OTP1 without the compensation mechanism of the present invention, and a curve 62 represents the first over-temperature protection signal OTP1 with the compensation mechanism of the present invention. The case without the compensation mechanism of the present invention refers to the first comparison circuit 163 comparing the first sensing voltage signal Vsense1 with the first reference voltage VREF to generate the first over-temperature protection signal OTP1. As shown in FIG. 6A, due to the channel length modulation effect, the first sensing voltage signal Vsense1 varies not only with temperature but also with the input voltage signal VIN. Therefore, at a point P, the first sensing voltage signal Vsense1 reaches (i.e., is greater than or equal to) the first reference voltage VREF, which causes the first over-temperature protection signal OTP1 to switch from a low level to a high level at a point N. However, at this time, the power switch 12 is still operating at 25° C., and the first sensing voltage signal Vsense1 reaches the first reference voltage VREF only due to an increase in the input voltage signal VIN, which causes the first over-temperature protection signal OTP1 to erroneously switch from a low level to a high level at the point N, where switching is unnecessary, and consequently causes the power switch 12 to be turned off. In contrast, as shown in FIG. 6B, with the compensation mechanism of the present invention, the first sensing voltage signal Vsense1 still varies with the input voltage signal VIN due to the channel length modulation effect, and the compensated reference voltage signal VREFOT adaptively also varies with the input voltage signal VIN. Therefore, as shown in FIG. 6B, the first over-temperature protection signal OTP1 with the compensation mechanism does not erroneously switch to a high level, to more accurately reflect temperature changes and eliminate the impact of variations in the input voltage signal VIN on sensing.

Further, please refer to FIG. 7A and FIG. 7B. FIG. 7A and FIG. 7B are schematic diagrams illustrating the timing of level changes of the first over-temperature protection signal OTP1 without and with the compensation mechanism of the present invention, respectively. In FIG. 7A and FIG. 7B, the horizontal axis represents the temperature of the power switch 12, the vertical axis represents voltage, curves 70 and 71 represent the first sensing voltage signal Vsense1 under higher and lower input voltage signals VIN, respectively, curve 73 represents a level of the first reference voltage VREF, curves 74 and 75 represent the first over-temperature protection signal OTP1 under different conditions without the compensation mechanism of the present invention, curves 78 and 79 represent the first over-temperature protection signal OTP1 under different conditions with the compensation mechanism of the present invention, and curves 76 and 77 represent the compensated reference voltage signal VREFOT under higher and lower input voltage signals VIN, respectively. As previously described, due to the channel length modulation effect, the first sensing voltage signal Vsense1 varies not only with temperature but also with the input voltage signal VIN. Therefore, as shown in FIG. 7A and FIG. 7B, at the same temperature of the power switch 12, the level of the curve 70 is higher than that of the curve 71. In this case, as shown in FIG. 7A, at a point P1, the curve 70 (corresponding to the first sensing voltage signal Vsense1 under a higher input voltage signal VIN) reaches (i.e., is greater than or equal to) the curve 73 (the first reference voltage VREF), which causes the curve 74 (the first over-temperature protection signal OTP1) to switch from a low level to a high level at a point N1, where the temperature of the power switch 12 is t1. At a point P2, the curve 71 (corresponding to the first sensing voltage signal Vsense1 under a lower input voltage signal VIN) reaches (i.e., is greater than or equal to) the curve 73 (the first reference voltage VREF), which causes the curve 75 (the first over-temperature protection signal OTP1) to switch from a low level to a high level at a point N2, where the temperature of the power switch 12 is t2. Thus, without the compensation mechanism of the present invention, the over-temperature protection threshold temperature of the power switch 12 changes from t1 to t2 under high and low input voltage signals VIN. This phenomenon causes the trigger point of over-temperature protection to vary with changes in the input voltage signal VIN, which fails to accurately reflect the actual temperature of the power switch 12, thereby affecting the reliability and safety of the system.

In contrast, as shown in FIG. 7B, at a point P3, the curve 70 (corresponding to the first sensing voltage signal Vsense1 under a higher input voltage signal VIN) reaches (i.e., is greater than or equal to) the curve 76 (corresponding to the compensated reference voltage signal VREFOT under a higher input voltage signal VIN), which causes the curve 78 (the first over-temperature protection signal OTP1) to switch from a low level to a high level at a point N3, where the temperature of the power switch 12 is t3. At a point P4, the curve 71 (corresponding to the first sensing voltage signal Vsense1 under a lower input voltage signal VIN) reaches (i.e., is greater than or equal to) the curve 77 (corresponding to the compensated reference voltage signal VREFOT under a lower input voltage signal VIN), which causes the curve 79 (the first over-temperature protection signal OTP1) to switch from a low level to a high level at the same point N3, where the temperature of the power switch 12 is t3. Thus, with the compensation mechanism of the present invention, the over-temperature protection threshold temperature of the power switch 12 remains at t3 under both high and low input voltage signals VIN, without variation. In other words, regardless of how the input voltage signal VIN varies, the trigger temperature for over-temperature protection of the power switch 12 remains stable at t3 with the compensation mechanism of the present invention, so as to eliminate the impact of variations in the input voltage signal VIN on temperature sensing, ensure consistent trigger points for over-temperature protection, and significantly improve the accuracy and stability of the system.

Therefore, as shown in FIG. 7A and FIG. 7B, without the compensation mechanism of the present invention (FIG. 7A), the trigger temperature for over-temperature protection varies with the input voltage signal VIN, from t1 to t2, which leads to inconsistency. With the compensation mechanism of the present invention (FIG. 7B), the trigger temperature for over-temperature protection remains fixed at t3, which is unaffected by changes in the input voltage signal VIN, so as to ensure consistency and reliability.

In short, the compensation mechanism of the present invention dynamically adjusts the reference voltage signal VREFOT, to effectively offset or compensate for the impact of the channel length modulation effect on the first sensing voltage signal Vsense1, and ensure that the trigger point for over-temperature protection remains consistent under different input voltage signals VIN, thereby ensuring the accuracy of temperature sensing and the stability of the system.

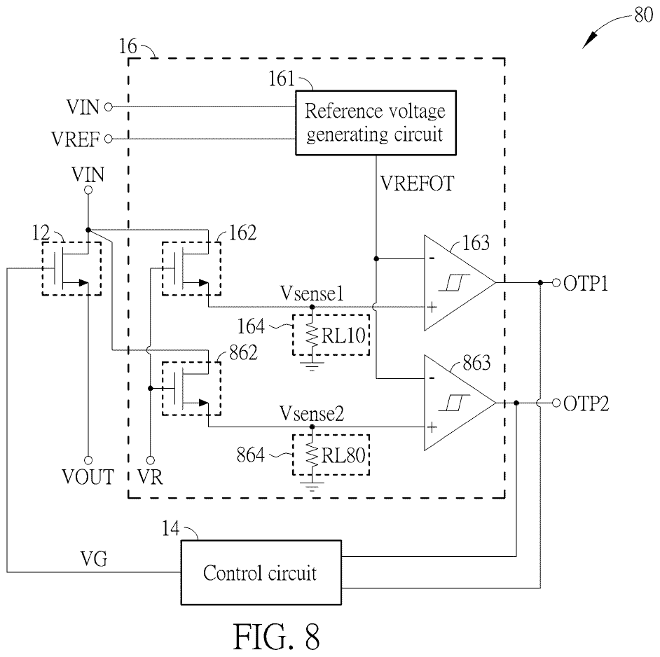

It should be noted that in the power supply device 10, the temperature sensing circuit 16 senses the temperature of the power switch 12 using a single first MOSFET 162. However, this is not limiting, and those skilled in the art may use two or more MOSFETs as temperature sensing elements to sense temperatures at different locations on the power switch 12. For example, please refer to FIG. 8, which is a schematic diagram of a power supply device 80 according to another embodiment of the present invention. The power supply device 80 is derived from the power supply device 10, and thus identical components are denoted by identical symbols. The power supply device 80 differs from the power supply device 10 in that the temperature sensing circuit 16 further includes a second MOSFET 862, a second comparison circuit 863, and a load 864. Referring to FIG. 8, in this embodiment, the load 864 is implemented by a resistor RL80. In an MCM packaging architecture, the power switch 12, the first MOSFET 162, and the second MOSFET 862 are disposed on one chip, while the control circuit 14, the reference voltage generating circuit 161, the first comparison circuit 163, the second comparison circuit 863, and the loads 164 and 864 are disposed on another chip. The second MOSFET 862, which serves as another temperature sensing element, senses a temperature at a different location on the power switch 12 compared to the first MOSFET 162. Otherwise, the operations of the second MOSFET 862 and the second comparison circuit 863 are substantially the same as those of the first MOSFET 162 and the first comparison circuit 163. Specifically, a drain of the second MOSFET 862 is electrically connected to the input voltage signal VIN, a gate thereof is electrically connected to the second reference voltage VR, and a source thereof generates a second sensing voltage signal Vsense2. Additionally, one end of the resistor RL80 is electrically connected between the source of the second MOSFET 862 and a positive terminal (+) of the second comparison circuit 863, while the other end of the resistor RL80 is electrically connected to a ground terminal. The positive terminal (+) of the second comparison circuit 863 receives the second sensing voltage signal Vsense2, and the negative terminal (−) thereof is electrically connected to the reference voltage generating circuit 161 to receive the reference voltage signal VREFOT. The second comparison circuit 863 compares the second sensing voltage signal Vsense2 with the reference voltage signal VREFOT to generate a second over-temperature protection signal OTP2 and outputs it to the control circuit 14, to enable the control circuit 14 to adjust the control signal VG accordingly.

In the power supply device 80, the control circuit 14 adjusts the control signal VG based on the first over-temperature protection signal OTP1 and the second over-temperature protection signal OTP2, and may include an OR gate to perform an OR operation on these signals, so as to adjust the control signal VG based on the result of the OR operation. Specifically, when either the first over-temperature protection signal OTP1 or the second over-temperature protection signal OTP2 indicates an over-temperature condition, the control circuit 14 triggers protection. Additionally, the control circuit 14 may determine a specific location of a temperature anomaly on the power switch 12 based on different over-temperature protection signals, to enable finer temperature management.

It should be noted that the power supply device 80 shown in FIG. 8 includes two temperature sensing elements (the first MOSFET 162 and the second MOSFET 862). In practice, depending on system requirements and design considerations, those skilled in the art may appropriately dispose multiple temperature sensing elements at different locations on the power switch 12 and configure corresponding comparison circuits, not limited to two, to achieve more comprehensive temperature monitoring. Whether a single or multiple temperature sensing elements are disposed on the power switch 12, the power supply device of the present invention utilizes the input voltage slope compensation technique to achieve precise monitoring and real-time regulation of the temperature of the power switch, and overcome the inaccuracies and response delays in temperature sensing found in the prior art, thereby enhancing the performance and reliability of the system.

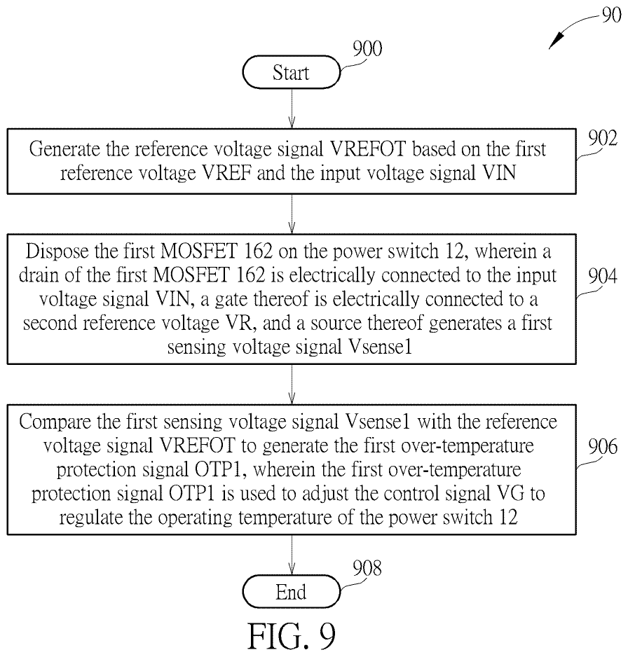

The operations of the power supply devices 10 and 80 described above can be summarized into a temperature regulation process 90, as shown in FIG. 9. The temperature regulation process 90 includes the following steps:
Step 900: Start.
Step 902: Generate the reference voltage signal VREFOT based on the first reference voltage VREF and the input voltage signal VIN.
Step 904: Dispose the first MOSFET 162 on the power switch 12, wherein a drain of the first MOSFET 162 is electrically connected to the input voltage signal VIN, a gate thereof is electrically connected to a second reference voltage VR, and a source thereof generates a first sensing voltage signal Vsense1.
Step 906: Compare the first sensing voltage signal Vsense1 with the reference voltage signal VREFOT to generate the first over-temperature protection signal OTP1, wherein the first over-temperature protection signal OTP1 is used to adjust the control signal VG to regulate the operating temperature of the power switch 12.
Step 908: End.

The detailed operations of the temperature regulation process 90 can be referred to the foregoing description and are not repeated here.

In the prior art, temperature monitoring of a power switch typically relies on conventional BJT temperature sensing elements. Due to process limitations, BJT temperature sensing elements cannot be directly disposed on the platform of the power switch, and result in inaccurate temperature sensing and response delays, which fail to reflect the actual temperature of the power switch in a timely manner, thereby increasing the risk of system damage in over-temperature conditions. The present invention directly disposes a temperature sensing element on the power switch and incorporates the input voltage slope compensation technique, to achieve precise monitoring and real-time regulation of the temperature of the power switch, effectively overcome the deficiencies of the prior art and enhance the performance and reliability of the system.

In summary, the power supply device and the temperature regulation method of the present invention directly dispose the temperature sensing element on the power switch and utilize the input voltage slope compensation technique, to effectively address the issues of inaccurate temperature sensing and response delays in the prior art, and achieve precise monitoring and real-time regulation of the temperature of the power switch, thereby enhancing the performance and reliability of the system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power supply device, configured to receive an input voltage signal and generate an output voltage signal, comprising:
a power switch, configured to convert the input voltage signal into the output voltage signal based on a control signal;
a control circuit, configured to generate the control signal to drive the power switch, and configured to adjust the control signal based on a first over-temperature protection signal to regulate an operating temperature of the power switch; and
a temperature sensing circuit, comprising:
a reference voltage generating circuit, configured to generate a reference voltage signal based on a first reference voltage and the input voltage signal;
a first metal-oxide-semiconductor field-effect transistor (MOSFET), disposed on the power switch, wherein the first MOSFET comprises a drain electrically connected to the input voltage signal, a gate electrically connected to a second reference voltage, and a source generating a first sensing voltage signal; and
a first comparison circuit, electrically connected to the source of the first MOSFET to receive the first sensing voltage signal and further electrically connected to the reference voltage generating circuit and the control circuit, configured to compare the first sensing voltage signal with the reference voltage signal to generate the first over-temperature protection signal, and configured to output the first over-temperature protection signal to the control circuit.

2. The power supply device of claim 1, wherein the temperature sensing circuit further comprises:
a load, having one end electrically connected between the source of the first MOSFET and the first comparison circuit, and another end electrically connected to a ground terminal.

3. The power supply device of claim 1, wherein the first MOSFET is based on a negative temperature coefficient characteristic of a threshold voltage of the first MOSFET to generate the first sensing voltage signal according to the input voltage signal, such that the first sensing voltage signal exhibits a positive temperature coefficient characteristic.

4. The power supply device of claim 1, wherein the power switch, the control circuit, and the temperature sensing circuit are integrated into a multi-chip module (MCM) packaging architecture.

5. The power supply device of claim 1, wherein the reference voltage generating circuit comprises:
a voltage divider circuit, electrically connected to the input voltage signal, configured to generate a divided voltage signal of the input voltage signal;
a first voltage-to-current conversion circuit, electrically connected to the voltage divider circuit, configured to convert the divided voltage signal into a first current;
a first current mirror, electrically connected to the first voltage-to-current conversion circuit, configured to convert the first current into a second current, wherein the first current and the second current are in a proportional relationship;
a second voltage-to-current conversion circuit, configured to convert the first reference voltage into a third current;
a second current mirror, electrically connected to the second voltage-to-current conversion circuit, configured to convert the third current into a fourth current; and
a current-to-voltage conversion circuit, electrically connected to the first current mirror, the second current mirror, and the first comparison circuit, configured to sum the second current and the fourth current and convert a summed result of the second current and the fourth current into a voltage signal to generate the reference voltage signal.

6. The power supply device of claim 5, wherein a component of the input voltage signal in the reference voltage signal is related to a ratio of the divided voltage signal to the input voltage signal and the proportional relationship.

7. The power supply device of claim 1, wherein the temperature sensing circuit further comprises:
a second MOSFET, disposed on the power switch, wherein the second MOSFET comprises a drain electrically connected to the input voltage signal, a gate electrically connected to the second reference voltage, and a source generating a second sensing voltage signal; and
a second comparison circuit, electrically connected to the source of the second MOSFET to receive the second sensing voltage signal and further electrically connected to the reference voltage generating circuit and the control circuit, configured to compare the second sensing voltage signal with the reference voltage signal to generate a second over-temperature protection signal, and configured to output the second over-temperature protection signal to the control circuit;
wherein the control circuit adjusts the control signal based on the first over-temperature protection signal and the second over-temperature protection signal to regulate the operating temperature of the power switch; and
wherein the first MOSFET and the second MOSFET are disposed at different locations on the power switch.

8. The power supply device of claim 7, wherein the control circuit comprises an OR gate, configured to perform an OR operation on the first over-temperature protection signal and the second over-temperature protection signal, and adjust the control signal based on a result of the OR operation.

9. The power supply device of claim 1, wherein the control circuit is further configured to determine a location of a temperature anomaly based on the first over-temperature protection signal.

10. The power supply device of claim 1, wherein the input voltage signal varies due to a channel length modulation effect of the power switch, and the reference voltage signal is configured to compensate for a portion of the first sensing voltage signal affected by the variation of the input voltage signal.

11. A temperature regulation method for a power supply device, wherein a power switch of the power supply device is configured to convert an input voltage signal into an output voltage signal based on a control signal, the temperature regulation method comprising:
generating a reference voltage signal based on a first reference voltage and the input voltage signal;
disposing a first metal-oxide-semiconductor field-effect transistor (MOSFET) on the power switch, wherein the first MOSFET comprises a drain electrically connected to the input voltage signal, a gate electrically connected to a second reference voltage, and a source generating a first sensing voltage signal; and
comparing the first sensing voltage signal with the reference voltage signal to generate a first over-temperature protection signal, wherein the first over-temperature protection signal is used to adjust the control signal to regulate an operating temperature of the power switch.

12. The temperature regulation method of claim 11, further comprising electrically connecting one end of a load between the source of the first MOSFET and a ground terminal.

13. The temperature regulation method of claim 11, wherein the first MOSFET is based on a negative temperature coefficient characteristic of a threshold voltage of the first MOSFET to generate the first sensing voltage signal according to the input voltage signal, such that the first sensing voltage signal exhibits a positive temperature coefficient characteristic.

14. The temperature regulation method of claim 11, wherein the power switch and the first MOSFET are integrated into a multi-chip module (MCM) packaging architecture.

15. The temperature regulation method of claim 11, wherein generating the reference voltage signal comprises:
dividing the input voltage signal to generate a divided voltage signal of the input voltage signal;
converting the divided voltage signal into a first current;
converting the first current into a second current, wherein the first current and the second current are in a proportional relationship;
converting the first reference voltage into a third current;
converting the third current into a fourth current; and
summing the second current and the fourth current, and converting a summed result of the second current and the fourth current into a voltage signal to generate the reference voltage signal.

16. The temperature regulation method of claim 15, wherein a component of the input voltage signal in the reference voltage signal is related to a ratio of the divided voltage signal to the input voltage signal and the proportional relationship.

17. The temperature regulation method of claim 11, further comprising:
disposing a second MOSFET on the power switch, wherein the second MOSFET comprises a drain electrically connected to the input voltage signal, a gate electrically connected to the second reference voltage, and a source generating a second sensing voltage signal; and
comparing the second sensing voltage signal with the reference voltage signal to generate a second over-temperature protection signal;
wherein the first over-temperature protection signal and the second over-temperature protection signal are used to adjust the control signal to regulate the operating temperature of the power switch; and
wherein the first MOSFET and the second MOSFET are disposed at different locations on the power switch.

18. The temperature regulation method of claim 17, further comprising performing an OR operation on the first over-temperature protection signal and the second over-temperature protection signal, and adjusting the control signal based on a result of the OR operation.

19. The temperature regulation method of claim 11, further comprising determining a location of a temperature anomaly based on the first over-temperature protection signal.

20. The temperature regulation method of claim 11, wherein the input voltage signal varies due to a channel length modulation effect of the power switch, and the reference voltage signal is configured to compensate for a portion of the first sensing voltage signal affected by the variation of the input voltage signal.
